(19) United States
(12) Patent Application Publication
(10) Pub. No.: US 2020/0272914 A1
(43) Pub. Date: Aug. 27, 2020

(54) CONTEXT-BASED RECOMMENDATIONS BASED ON ENVIRONMENT INTERACTIONS

(71) Applicant: Microsoft Technology Licensing, LLC, Redmond, WA (US)

(72) Inventors: Kevin J. Jeyakumar, Seattle, WA (US); Joy Hui, Seattle, WA (US); Alex J. Woo, Seattle, WA (US)

(21) Appl. No.: 16/285,125

(22) Filed: Feb. 25, 2019

(51) Int. Cl. G06N 5/04; G06N 20/00; G06F 16/2457

(52) U.S. Cl. CPC G06N 5/04; G06F 16/24575; G06N 20/00

(57) ABSTRACT

Methods, systems, apparatuses, and computer-readable storage mediums described herein are configured to determine contextually-relevant information for a user and provide that information to the user in a personalized manner For instance, a user may enter an environment. Sensors located in that environment are utilized to identify the user. Upon identifying the user, previously-collected information pertaining to that user is accessed. Sensor data collected from sensors located in other environments visited by the user is also accessed. Sensors in the present environment is utilized to monitor and/or track the identified user as he navigates through the environment. The collected sensor data is utilized to determine an activity the user performs in the environment and/or predict an activity that a user is likely to perform in the environment. Contextually-relevant information pertaining to such activities is determined based on both present sensor data and historical sensor data of that user.

### BACKGROUND

As computing devices become increasingly powerful and ubiquitous, users increasingly use them for a broad variety of tasks. For example, in addition to traditional activities, such as running productivity applications, computing devices are increasingly used by users as an integral part of their daily lives. Moreover, such devices may be present during virtually all of a person's daily activities. For instance, mobile computing devices, such as smart phones and wearable computing devices, are increasingly common. Such devices are designed to act as constant companions and intelligent assistants to users, being available to present information to their user at any time.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, apparatuses, and computer-readable storage mediums described herein are configured to determine contextually-relevant information for a user and provide that information to the user in a personalized manner. For instance, a user may enter an environment. Sensors located in that environment may be utilized to identify the user. Upon identifying the user, previously-collected information pertaining to that user, including information associated with that environment, may be accessed. Sensor data collected from sensors located in other environments visited by the user may also be accessed. Sensors in the environment in which the user is identified may be utilized to monitor and/or track the identified user as he or she navigates through the environment. The collected sensor data may be utilized to determine an activity the user performs in the environment and/or predict an activity that a user is likely to perform in the environment. Contextually-relevant information pertaining to such activities and useful to the user may be determined based on both present sensor data and historical sensor data of that user. The information may be provided to the user automatically, without requiring the user to explicitly request such information. Accordingly, relevant information is provided to the user based on the user's context (e.g., where the user is, where the user has been, and what the user is doing).

Further features and advantages, as well as the structure and operation of various example embodiments, are described in detail below with reference to the accompanying drawings. It is noted that the example implementations are not limited to the specific embodiments described herein. Such example embodiments are presented herein for illustrative purposes only. Additional implementations will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate example embodiments of the present application and, together with the description, further serve to explain the principles of the example embodiments and to enable a person skilled in the pertinent art to make and use the example embodiments.

FIG. 1 shows a block diagram of an example system configured to determine contextually-relevant information based on a user's environment in accordance with an embodiment.

FIG. 2 shows a block diagram of an example system for determining contextually-relevant information for a user based on an environment populated by sensors in accordance with another embodiment.

FIG. 3 shows a flowchart of a method for determining contextually-relevant information based on a user's environment in accordance with an example embodiment.

FIG. 4 shows a block diagram of the system of FIG. 2, showing example detail of the context-based recommendation engine, in accordance with another embodiment.

FIG. 5 shows a flowchart of a method for formatting and providing the contextually-relevant information to a device in accordance with an example embodiment.

FIG. 6 shows a block diagram of a context-based recommendation engine configured to format and provide contextually-relevant information to a device in accordance with an example embodiment.

FIG. 7 is a block diagram of an example mobile device that may be used to implement various embodiments.

FIG. 8 is a block diagram of an example processor-based computer system that may be used to implement various embodiments.

The features and advantages of the implementations described herein will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification and accompanying drawings disclose numerous example implementations. The scope of the present application is not limited to the disclosed implementations, but also encompasses combinations of the disclosed implementations, as well as modifications to the disclosed implementations. References in the specification to “one implementation,” “an implementation,” “an example embodiment,” “example implementation,” or the like, indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of persons skilled in the relevant art(s) to implement such feature, structure, or characteristic in connection with other implementations whether or not explicitly described.

In the discussion, unless otherwise stated, adjectives such as “substantially” and “about” modifying a condition or relationship characteristic of a feature or features of an implementation of the disclosure, should be understood to mean that the condition or characteristic is defined to within tolerances that are acceptable for operation of the implementation for an application for which it is intended.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

Numerous example embodiments are described as follows. It is noted that any section/subsection headings provided herein are not intended to be limiting. Implementations are described throughout this document, and any type of implementation may be included under any section/subsection. Furthermore, implementations disclosed in any section/subsection may be combined with any other implementations described in the same section/subsection and/or a different section/subsection in any manner

### II. Example Implementations

Embodiments described determine contextually-relevant information for a user and provide that information to the user in a personalized manner For instance, as a user enters an environment, sensors located in that environment may be utilized to identify the user. For instance, a user may enter an environment. Sensors located in that environment may be utilized to identify the user. Upon identifying the user, previously-collected information pertaining to that user, including information associated with that environment, may be accessed. Sensor data collected from sensors located in other environments visited by the user may also be accessed. Sensors in the environment in which the user is identified may be utilized to monitor and/or track the identified user as he or she navigates through the environment. The collected sensor data may be utilized to determine an activity the user performs in the environment and/or predict an activity that a user is likely to perform in the environment. Contextually-relevant information pertaining to such activities and useful to the user may be determined based on both present sensor data and historical sensor data of that user. The information may be provided to the user automatically, without requiring the user to explicitly request such information. Accordingly, embodiments described herein provide relevant information to the user based on the user's context (e.g., where the user is, where the user has been, and what the user is doing).

Accordingly, the particular arrangement of sensors utilized to determine contextually-relevant information (i.e., sensors located in different environments), provides a technical improvement over the current state of the art for providing information to a user—in particular, more relevant, user-specific information.

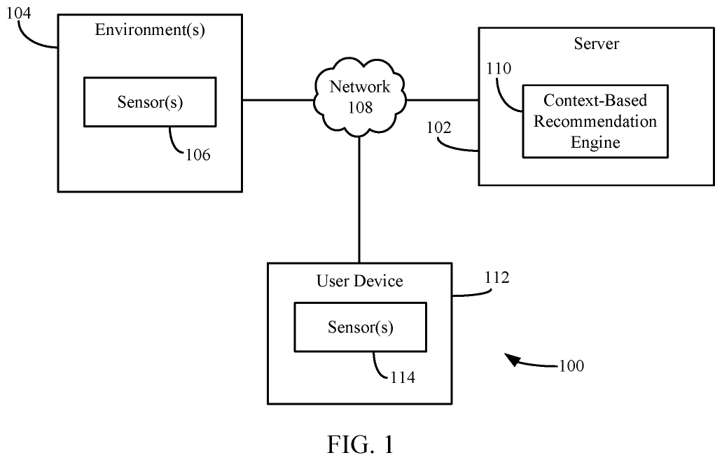

For instance, FIG. 1 shows a block diagram of an example system 100 for determining contextually-relevant information based on a user's environment in accordance with an embodiment. As shown in FIG. 1, system 100 includes a server 102, one or more environments 104, and a user device 112. Each environment of environment(s) 104 may include a residence (e.g., the user's residence or another person's residence), a business or organization (such as a restaurant, an airport, a library, a hotel, a coffee shop, a bookstore, a department store, a supermarket, a fitness gym, a factory, a repair shop, etc.), and/or one or more various other private or public establishments or locations (e.g., a museum, a city park, a national park, a healthcare institution (such as a hospital), etc.). Environment(s) 104 may comprise any number of environments. Each of environment(s) 104 may include one or more sensors 106. Each sensor of sensor(s) 106 is configured to detect one or more events and/or changes in its respective environment. Each sensor of sensor(s) 106 is configured to send sensor data corresponding to the detected event(s) and/or change(s) to a computing device (e.g., server 102) for analysis thereby. Sensor(s) 106 may comprise any number of sensors.

For instance, sensors(s) 106, server 102, and user device 112 may be communicatively coupled via network 108. Network 108 may comprise one or more networks such as local area networks (LANs), wide area networks (WANs), enterprise networks, the Internet, etc., and may include one or more of wired and/or wireless portions. Sensor(s) 106, server 102, and user device 112 may communicate with each other via network 108 through a respective network interface. In an embodiment, sensor(s) 106, server 102, and user device 112 may communicate via one or more application programming interfaces (API). In other embodiments, sensor(s) 106 may be communicatively coupled to one or more computing devices located at their respective environment. In accordance with such embodiments, sensor(s) 106 may send sensor data to the computing device(s), and the computing device(s) may send the sensor data to server 102 via network 108. Examples of computing device(s) include, but are not limited to, a desktop computer, a laptop, a smart phone, a tablet, a personal data assistant, a wearable computing device (e.g., an augmented reality headset, a smart watch, etc.), and/or the like. In additional embodiments, sensor(s) 106 may be incorporated into such computing device(s).

Server 102 may be included, for example, in a network-accessible server infrastructure. In an embodiment, server 102 may form a network-accessible server set, such as a cloud computing server network. For example, server 102 may comprise a group or collection of servers (e.g., computing devices) that are each accessible via a network such as the Internet (e.g., in a “cloud-based” embodiment) to store, manage, and process data. Server 102 may comprise any number of servers, and may include any type and number of other resources, including resources that facilitate communications with and between the servers, storage by the servers, etc. (e.g., network switches, storage devices, networks, etc.). Server 102 may also be maintained locally in environment(s) 104.

Server 102 may comprise and/or execute a context-based recommendation engine 110. Context-based recommendation engine 110 may be configured to analyze sensor data received from sensor(s) 106 to identify one or more users and/or one or more objects in environment(s) 104, determine one or more activities of user(s) in environment(s) 104, and/or provide (or recommend) contextually-relevant information to the user(s) based on the user's activit(ies) in environment(s) 104. The contextually-relevant information may be provided to user device 112 via network 108. Examples of user device 112 include, but are not limited to, a mobile device that is carried by and/or worn by the user, such as a notebook computer, a laptop computer, a tablet computer such as an Apple iPad™, a mixed device (e.g., a Microsoft® Surface® device), a netbook, a mobile phone (e.g., a cell phone, a smart phone such as an Apple iPhone®, a phone implementing the Google® Android™ operating system, etc.), a smart watch, a head-mounted device including smart glasses such as Google® Glass™, Oculus Rift® by Oculus VR, LLC, etc., an augmented reality headset including Microsoft® HaloLens™, another type of wearable computing device, etc. In accordance with an embodiment, user device 112 may further include any of the sensors described herein. For instance, as shown in FIG. 1, user device 112 includes sensor(s) 114. Context-based recommendation engine 110 may be configured to analyze sensor data received from sensor(s) 114 in addition to or in lieu of sensor(s) 106 to identify one or more users and/or one or more objects in environment(s) 104, determine one or more activities of user(s) in environment(s) 104, and/or provide (or recommend) contextually-relevant information to the user(s) based on the user's activit(ies) in environment(s) 104. Additional details regarding context-based recommendation engine 110 are described below.

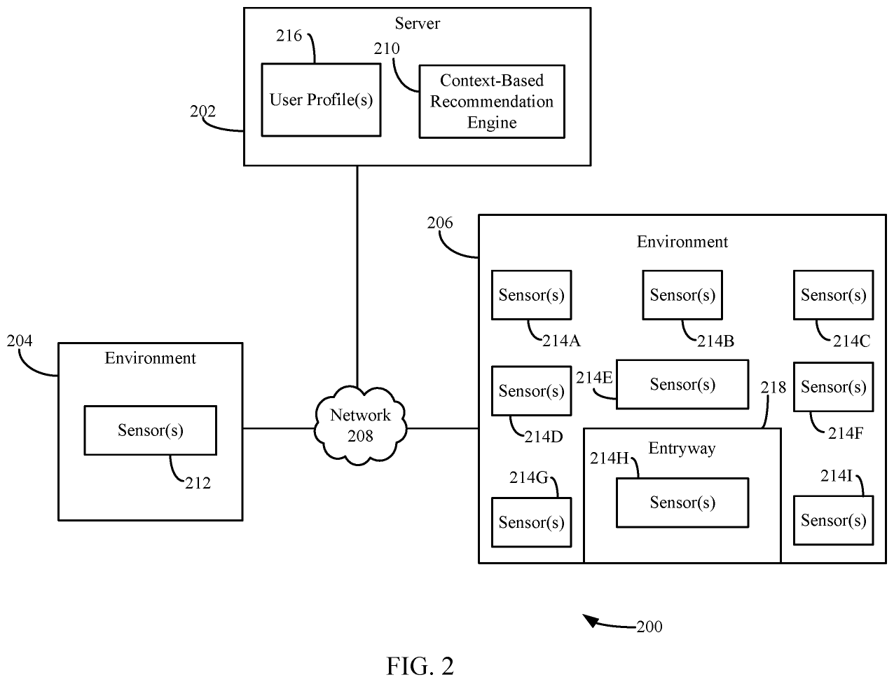

FIG. 2 shows a block diagram of an example system 200 for determining contextually-relevant information based on a user's environment in accordance with another embodiment. As shown in FIG. 2, system 200 includes a server 202, a first environment 204, and a second environment 206. Server 202 is an example of server 102, as described above with reference to FIG. 1, and first environment 204 and second environment 206 are examples of environment(s) 104, as described above with reference to FIG. 1. Each of environments 204 and 206 may include sensor(s). For instance, environment 204 may include sensor(s) 212, and environment 206 may include sensor(s) 214A-214I. Sensor(s) 212 and sensor(s) 214A-214I are examples of sensor(s) 106, as described above with reference to FIG. 1. Sensor(s) 212 and sensor(s) 214A-214I may be communicatively coupled to server 202 via a network 208. Network 208 is an example of network 108, as described above with reference to FIG. 1. It is noted that while FIG. 2 depicts two environments (environments 204 and 206), the embodiments described herein may utilize any number of environments. It is further noted that sensor(s) 212 and sensor(s) 214A-214I may each comprise any number of sensors.

Sensor(s) 212 may be configured to detect event(s) and/or change(s) in environment 204, and sensor(s) 214A-214I may be configured to detect event(s) and/or change(s) in environment 206. For instance, sensor(s) 212 may be configured to detect and/or monitor user(s) and/or object(s) located within environment 204 and/or monitor the user(s)' activity within environment 204 and/or interactions with object(s) included therein. Sensor(s) 214A-214I may be configured to detect and/or monitor user(s) and/or object(s) located within environment 206 and/or monitor the user(s)' activity within environment 206 and/or interactions with object(s) included therein.

Examples of sensor(s) 212 and 214A-214I include, but are not limited to, a weight sensor, a monocular sensor, a wide-angle sensor, a thermal imaging sensor, a motion sensor, a time of flight-based sensor, a wireless network-based sensor, a Bluetooth™-based sensor, a radio frequency identification-based sensor, a biometric sensor, or a global-position system-based sensor. It is noted that sensor(s) 212 and 214A-214I may comprise other types of sensors and the sensors described herein are purely exemplary.

A weight sensor may measure the weight of a user. A weight sensor may be incorporated into a body weight scale. A monocular sensor may be configured to capture images and/or video through a single lens, two-dimensional camera. A monocular sensor may be utilized to detect each time a user enters a particular environment and/or to count the number of users that enter an environment. A wide-angle sensor may be configured to capture images and/or video via a wide-angle lens. A wide-angle sensor may be utilized to continuously track a user as he or she moves around an environment. A wide-angle sensor may be incorporated in a three-dimensional stereo video sensor.

A thermal imaging sensor may be configured to form a heat zone image using infrared radiation. A thermal imaging sensor may be utilized to detect each time a user enters a particular environment and/or to count the number of users that enter an environment. A motion sensor may detect movement within an environment and may be utilized to detect each time a user enters a particular environment and/or to count the number of users that enter an environment. A motion sensor may utilize infrared-based techniques, microwave-based techniques, ultrasonic-based techniques, vibration-based techniques, and/or the like.

A time-of-flight based sensor may be configured to measure the time-of-flight of a flight signal between a device (e.g., a camera) and an object or user. The sensor may be utilized to determine a precise positioning of users(s) and/or object(s). A biometric sensor may be configured to identify a user based on a biometric feature of the user (e.g., using facial recognition techniques, retinal scanning techniques, fingerprint reading techniques, etc.).

A wireless network-based sensor (e.g., a Wi-Fi sensor) may be configured to sense radio waves from mobile devices carried by the user (e.g., mobile phones, tablets, etc.). The radio waves may be analyzed using triangulation techniques to track the location and/or movement of the mobile device (and therefore the user). A Bluetooth™-based sensor may be configured to sense radio waves (e.g., beacons transmitted via the radio waves) from mobile devices carried by the user (e.g., mobile phones, tablets, etc.). The radio waves may be analyzed using triangulation techniques to track the location and/or movement of the mobile device (and therefore the user).

A GPS-based sensor may be configured to track a mobile device's user location and/or movement based on GPS signals transmitted by the mobile device.

A RFID-based sensor may be configured to sense electromagnetic fields emitted from an RF antenna to identify and/or track an object to which the RF antenna is included. For instance, an RF antenna may be incorporated into a tag device that is affixed to or incorporated with an object. The tag device may further comprise a unique identification that uniquely identifies the object. The RFID-based sensor may scan such tags to determine objects (including such tags) that are located within an environment. The RFID-based sensor may be utilized to obtain an inventory of objects within an environment, track movement of such objects within the environment, etc.

Sensor(s) 212 and/or 214A-214A may further comprise user-worn body sensors, which can provide a variety of types of physiological information. Such sensors include, but are not limited to thermometers, sphygmometers, heart rate sensors, shiver response sensors, skin galvanometry sensors, eyelid blink sensors, pupil dilation detection sensors, EEG and EKG sensors, glucose monitors, etc.

It is noted that one or more of sensors described herein (e.g., sensor(s) 212 and/or sensor(s) 214A-214I) may be incorporated in a stand-alone device or may be incorporated in another device, such as a mobile device, a wearable computing device (e.g., a smart watch, an augmented reality headset, etc.), an Internet-of-Things (IOT)-based device, etc. Such devices may include any combination of the sensors described herein.

Each of sensor(s) 212 and/or sensor(s) 212A-212I may include an interface for transmitting sensor data to a computing device (e.g., server 202) for analysis thereby. The interface may include a wired connection (e.g., via a Universal Serial Bus (USB) cable, a IEEE 1394-based (i.e., Firewire) cable, an external Serial ATA cable, an RJ45 cable, etc.) and/or a wireless connection (e.g., via a IEEE 802.11 wireless LAN (WLAN) connection, Bluetooth™, ZigBee®, NFC, IEEE 802.11-based protocols, etc.). For instance, the interface may be utilized to transmit sensor data to server 202 via network 208.

Context-based recommendation engine 210 may be configured to analyze sensor data received from sensor(s) 212 of environment 204 and/or sensor(s) 214A-214I of environment 206. Context-based recommendation engine 210 is an example of context-based recommendation engine 110, as described above with reference to FIG. 1. Context-based recommendation engine 210 may be configured to determine various information pertaining to a particular user and/or the environment(s) in which the user has been based on the received sensor data. Context-based recommendation engine 210 may maintain such information for different user(s) in one or more user profiles 216. The information may comprise, but is not limited to, demographic information, biographical and/or physiological information, and/or behavioral and/or historical information. Demographic information may comprise, but is not limited to, a user's ethnicity, gender, age, religion, birthday, areas or topics of interests, etc. Biographical and/or physiological information may comprise, but is not limited to the user's weight, height, body mass index, posture, gait, heart rate, respiration rate, blood pressure, glucose levels, impairments, etc. Each of user profile(s) 216 may comprise behavioral and/or historical information. Behavioral and/or historical information may comprise, but is not limited to, objects with which the user interacts within a particular environment, an inventory of items or object within a particular environment, patterns of usage of objects within a particular environment, activity performed within a particular environment, patterns of movement and/or activity of the user within a particular environment, patterns of movement and/or activity of the user between different environments, etc.

It is noted that certain information (e.g., demographic information) may also be explicitly provided by the user. Thus, a user may make updates to his user profile in addition to or in lieu of updates made by context-based recommendation engine 210.

As shown in FIG. 2, sensor(s) 212 and/or sensor(s) 214A-214I may be situated in various places within an environment. For instance, with reference to environment 206, certain sensor(s) (e.g., sensor(s) 214H) may be situated at an entryway 218 of environment 206. Entryway 218 may comprise a doorway, a vestibule, a reception (or front) desk, a porch, a foyer, and/or any other region of environment 206 that a user enters as they walk into environment 206. Sensor(s) 214H may be configured to identify user(s) entering environment 206. For instance, sensor(s) 214H may comprise one or more of a biometric sensor, a weight sensor, a camera (e.g., monocular camera), an motion sensor, etc. Upon identifying a user, that user's profile (e.g., user profile(s) 216) may be accessed to determine information pertaining to the user. Such information may be utilized to determine contextually-relevant information to provide to the user as the user traverses environment 206.

As the user traverses other regions of environment 206, other sensors (e.g., sensor(s) 214A-214G and sensor(s) 2141 may be utilized to determine an activity being performed by the user. Certain sensors (e.g. sensor(s) 214E) may be centrally-located within environment 206, which may be configured to continuously track the user as he moves through environment 206. Examples of such sensors may include, but are not limited to, a wide-angle sensor, a Wi-Fi based sensor, Bluetooth™-based sensor, etc. The sensor data collected by sensor(s) 212 and/or 214A-214I may be used to update the user's profile.

Context-based recommendation engine 210 may be configured to provide information that is contextually-relevant based on the activity being performed by the user. The information may be based on sensor data obtained from sensor(s) 214A-214I of environment 206, along with sensor data obtained from other environment(s) in which the user was located (e.g., sensor data obtained from sensor(s) 212 of environment 204). For instance, suppose context-based recommendation engine 210 determines that a user is running low on or is out of a certain type of food product located in the user's home. Context-based recommendation engine 210 may determine this based on sensor data received from RF-based sensors that scan tag devices included on the food product, a monocular sensor, or any other sensor configured to track objects in a user's home. Such sensors may be located in the user's kitchen cabinet, refrigerator, pantry, etc. Such information may be stored in the user's profile. When a user enters a second environment (e.g., a grocery store), sensor(s) in the entryway (e.g., sensor(s) 214H of entryway 218) of the grocery store may identify the user, and context-based recommendation engine 210 may access that user's profile (e.g., user profile(s) 216). Context-based recommendation engine 210 may determine that the user is running low or is out of the food product based on the user profile and provide a notification to the user that should he or she purchase that food. The notification may further specify where to find that product in the store (e.g., an aisle number) and/or provide directions as to how to find that product in the grocery store.

In another example, context-based recommendation engine 210 may determine a user's dietary preferences and/or restrictions (e.g., based on user data explicitly provided by the user (e.g., demographic information), sensor data obtained from sensors that track which kinds of products the user purchases (e.g., vegetarian products, vegan products, Kosher products, etc.) in a first environment (such as a grocery store) and/or sensor data obtained from sensors that monitor the types of foods consumed in a second environment (e.g., the user's home). Such sensors include, but are not limited to, a wide-angle sensor, a monocular sensor, etc. When a user enters another environment, such as a restaurant, context-based recommendation engine 210 may notify the user of menu items offered at that restaurant that are in accordance with the user's dietary preference and/or restrictions. Still further, context-based recommendation engine 210 may also provide such information to employees of the restaurant, such as the waiter and/or chef. The employees, knowing that the user has dietary restrictions, may recommend certain menu items, or off-menu items (e.g., custom food items) to the user without the user having to inform the employees of his preferences and/or restrictions.

In yet another example, context-based recommendation engine 210 may determine that the user regularly visits a gym based on sensor data collected from sensor(s) located in the gym. When a user enters another environment, such as grocery store, context-based recommendation engine 210 may recommend to the user certain food products that are conducive to a healthy life style (e.g., vegetables and/or high protein foods).

In accordance with another embodiment, context-based recommendation engine 210 may be configured to provide information based on an activity being performed by the user within an environment. For instance, suppose a user visits an environment such as a fitness gym. As the user enters the gym (e.g., the user enters entryway 218), sensor(s) (e.g., sensor(s) 214H) may detect the user and/or send sensor data to context-based recommendation engine 210, which utilizes the sensor data to identify the user. Sensor(s) 214H may comprise a weight sensor that detects the user's weight, a monocular sensor, a biometric sensor, or any other sensor that may be used to identify the user. Context-based recommendation engine 210 may update the user's profile with the detected weight. Other sensor(s) within the gym (e.g., sensor(s) 214A-214H and 2141) may monitor the user and track where the user is going within the fitness gym. As a user approaches a particular exercise machine, context-based recommendation engine 210 may provide previous workout data pertaining to that machine to the user. For instance, the information may include a time and/or date at which the user last used the machine, an amount of weight previously lifted, the amount of repetitions of that weight, etc. When a user walks over to another machine, context-based recommendation engine 210 may provide previous workout data pertaining to that other machine. In this way, context-based recommendation engine 210 may provide meaningful information to the user at the right time and/or place.

In another example, context-based recommendation engine 210 may determine that the user is not making significant gains with respect to the user's exercise routine. For instance, context-based recommendation engine 210 may determine that the user's weight and or body mass index has not improved within a particular period of time. In response, context-based recommendation engine 210 may recommend different exercises or exercise routines for the user to perform. The different exercises or routines may be determined based on other user profiles for users that have successfully lowered their weight or improved their body mass index. For instance, context-based recommendation engine 210 may match user profiles that are similar to the user in terms of weight, age, gender, etc. For those matched profiles, context-based recommendation engine 210 may analyze historical information of those profiles to determine whether those users have successfully lowered their weight or improved their body mass index and determine the workout routines that were performed by that user based on those users' profiles. Such workout routines may be recommended to the user.

In accordance with an embodiment, context-based recommendation engine 210 determines whether the user performs the recommended activity. The determination may be based on sensor data received from sensor(s) that monitor the user as he traverses through the environment for which the recommendation was made. The determination may also be made based on user input provided by the user to which the recommendation was made. For instance, the recommendation may prompt the user to either accept or reject the recommended activity. In response to determining that the user has performed the recommended activity, context-based recommendation engine 210 may update user profile(s) 216 associated with the user to indicate the user performed the recommended activity. In response to determining that the user has not performed the recommended activity, context-based recommendation engine 210 may update user profile(s) 216 associated with the user to indicate that the user has not performed the recommended activity. Context-based recommendation engine 210 may factor in the positive and/or negative determinations when recommending activity to the user. By doing so, context-based recommendation engine 210 may fine tune the recommendations provided based on how the user reacts to the recommendations provided thereto.

In accordance with an embodiment, context-based recommendation engine 210 may determine (or predict) where a user is headed within an environment based on sensor data obtained from sensor(s) within the environment. Context-based recommendation engine may provide recommendations pertaining to that determined (or predicted) location. In anticipation of the user arriving at the location, the information may be provided to a device configured to display the information before the user arrives at that destination. This way, the information will be ready for display by the device by the time the user arrives at the location, thereby advantageously reducing the latency from when the user arrives at the location and waiting for the contextually-relevant information to be displayed.

In accordance with an embodiment, context-based recommendation engine 210 may utilize machine learning-based techniques to analyze the sensor data and determine contextually-relevant information that is to be provided the user. For instance, context-based recommendation engine 210 may utilize a classification model that is trained using a supervised learning and/or unsupervised learning algorithm. The model may be trained based on previous sensor data collected from the user and/or sensor data associated with other users. The model may be further trained based on determinations as to whether user(s) performed activities recommended thereto. In accordance with such an embodiment, context-based recommendation engine 210 provides the sensor data obtained for a user as an input to the model, and the model outputs contextually-relevant information that is to be provided to the user.

The contextually-relevant information may be provided to a device associated with a user. For instance, the device may be a mobile device carried or worn by the user (e.g., a smart phone, a PDA, a tablet, a laptop, an augmented reality headset, a smart watch, etc.). Alternatively, in addition or in lieu of providing the contextually-relevant information a mobile device, the contextually-relevant information may be provided to one or more stationary devices (e.g., a computer coupled to a display screen) located within the environment.

In accordance with an embodiment, context-based recommendation engine 210 may determine the device to which the contextually-based recommendation is to be provided. For instance, the user may carry or wear multiple devices capable of displaying contextually-relevant information (e.g., a smart phone, a smart watch and/or an augmented reality headset). The user may specify his or her preferred device for receiving contextually-relevant information for any given day and/or time. Such preferences may be stored in the user's user profile(s) 216. Context-based recommendation engine 210 may determine the user's preferences by analyzing his or her user profile and provide contextually-relevant information accordingly. Alternatively, context-based recommendation engine 210 may determine the device based on sensor data received from sensor(s) located in the environment in which the contextually-relevant information is to be provided. For instance, wireless network-based sensors and/or a Bluetooth™-based sensor may be utilized to detect a mobile device utilized by the user. Context-based recommendation engine 210 may provide the contextually-relevant information to the determined device. In the event that more than one device is detected, context-based recommendation engine 210 may utilize a prioritization scheme to determine the device to provide the contextually-relevant information (e.g., an augmented reality headset is prioritized over a smart watch, a smart watch is prioritized over a smart phone, etc.). If no such device is detected, context-based recommendation engine 210 may provide the contextually-relevant information to a stationary device coupled to a display screen located in the environment and that is within proximity of the user.

When providing the contextually-relevant information to the determined device, context-based recommendation engine 210 may determine one or more capabilities of the device (e.g., display resolution, audio capabilities, screen size, supported audio and/or video formats, communication protocol, etc.). Context-based recommendation engine 210 may query the device for its capabilit(ies). Alternatively, context-based recommendation engine 210 may access a device-to-capability mapping, which maps different devices to their respective capabilities. For instance, when a wireless-based and/or Bluetooth™-based sensor detects a mobile device, the mobile device may provide a unique identifier (e.g., a media access control (MAC) address) to the sensor. The sensor provides the identifier to context-based recommendation engine 210, which then performs a look up of that device's capabilities using the identifier and the mapping. The mapping may be maintained locally at server 202 or may be remotely maintained on another computing device.

Upon determining the device's capabilities, context-based recommendation engine 210 may format the contextually-relevant information in accordance with the device's capabilities. For instance, context-based recommendation engine 210 may communicate the information in accordance with the communication protocol supported by the device and/or format the contextually-relevant information to correctly fit on the device's display.

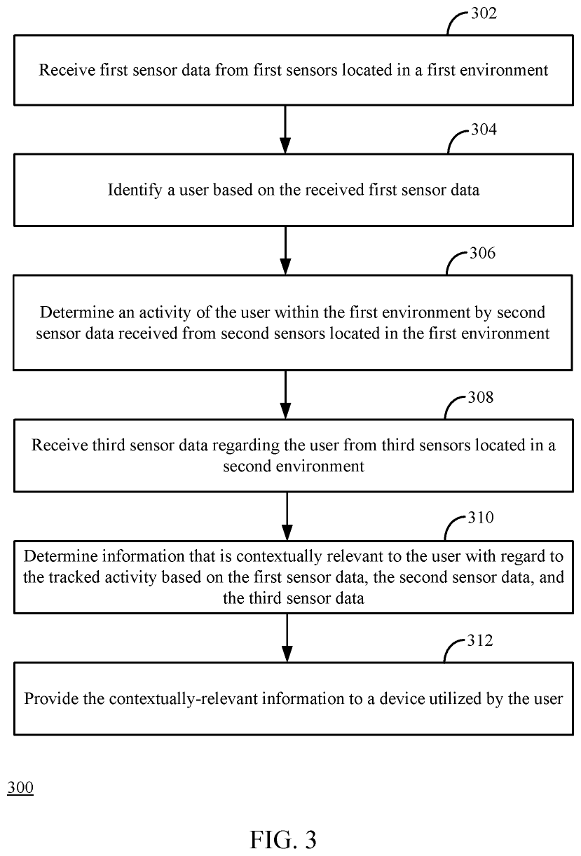

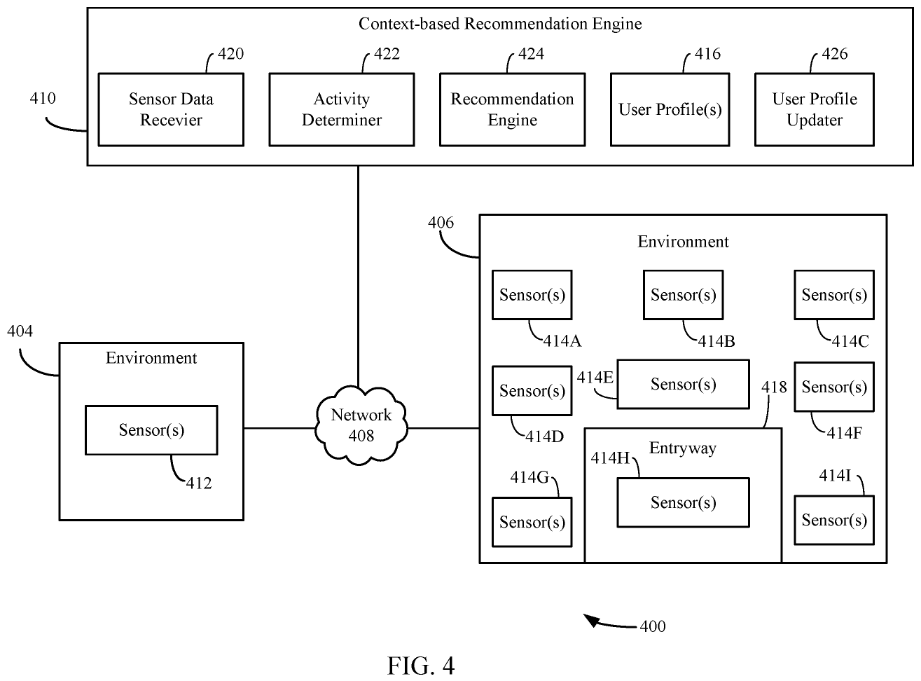

Accordingly, in example embodiments, context-based recommendation engine 210 may be configured to determine contextually-relevant information based on a user's environment in various ways. For instance, FIG. 3 shows a flowchart 300 of a method for determining contextually-relevant information based on a user's environment in accordance with an example embodiment. In an embodiment, flowchart 300 may be implemented by a context-based recommendation engine 410 shown in FIG. 4, although the method is not limited to that implementation. FIG. 4 shows a block diagram of a system 400 for determining contextually-relevant information based on a user's environment in accordance with an example embodiment. As shown in FIG. 4, system 400 includes context-based recommendation engine 410, an environment 404 and an environment 406. Context-based recommendation engine 410 is an example of context-based recommendation engine 210, as described above with reference to FIG. 2. Context-based recommendation engine 410 may include one or more user profiles 416, a sensor data receiver 420, an activity determiner 422, a recommendation engine 424, and a user profile updater 426. User profile(s) 416 are examples of user profile(s) 216, as described above with reference to FIG. 2. Environment 404 includes sensor(s) 412, and environment includes sensor(s) 414A-414I. Environment 404, environment 406, and sensor(s) 412, and sensor(s) 414A-414I are examples of environment 204, environment 206, sensor(s) 212, and sensor(s) 214A-214I, as respectively described above with reference to FIG. 2. Sensor(s) 412 and sensor(s) 414A-414I may be communicatively coupled to context-based recommendation engine 410 via a network 408. Network 408 is an example of network 208, as described above with reference to FIG. 2. Other structural and operational embodiments will be apparent to persons skilled in the relevant art(s) based on the discussion regarding flowchart 300 and system 400 of FIG. 4.

Flowchart 300 begins with step 302. In step 302, first sensor data is received from first sensors located in a first environment. For example, with reference to FIG. 4, sensor data receiver 420 may receive sensor data from sensor(s) 414H of entryway 418 of environment 406.

In step 304, a user is identified based on the received first sensor data. For instance, with reference to FIG. 4, activity determiner 422 may identify the user based on the received first sensor data.

In step 306, an activity of the user within the first environment is determined by second sensor data received from second sensors located in the first environment. For instance, with reference to FIG. 4, activity determiner 422 may determine an activity of the user within environment 406 by second sensor data received from sensor(s) 414A-414G and 414I. The second sensor data may be received by sensor data receiver 420.

In accordance with one or more embodiments, at least one of the first sensors may be the same sensor as at least one of the second sensors.

In accordance with one or more embodiments, the movement of the user within the first environment is continuously tracking via the second sensors. A destination within the first environment to which the user is headed is determined based on the continuous tracking. The contextually-relevant information is related to the determined destination. For example, with reference to FIG. 4, activity determiner 422 may utilize sensor data from a centrally-located sensor (e.g., sensor(s) 414E) to continuously track a user within environment 406. Activity determiner 422 may determine a destination within environment 406 to which the user is headed based on the continuous tracking.

In accordance with one or more embodiments, the contextually-relevant information is provided to the device before the user arrives at the destination. This way, the information will be ready for display by the device by the time the user arrives at the destination, thereby advantageously reducing the latency from when the user arrives at the destination and waiting for the contextually-relevant information to be displayed.

In step 308, third sensor data regarding the user from third sensors located in a second environment is received. For instance, with reference to FIG. 4, sensor data receiver 420 may receive third sensor data regarding the user from sensor(s) 412 located in environment 404.

In accordance with one or more embodiments, at least one of the first sensors may be the same sensor as at least one of the second sensors and/or at least one of the third sensors.

In accordance with one or more embodiments, at least one of the first sensors, the second sensors, or the third sensors are included in at least one of a smart phone or a wearable computing device.

In step 310, information that is contextually relevant to the user with regard to the tracked activity is determined based on the first sensor data, the second sensor data, and the third sensor data. For instance, recommendation engine 424 may determine information that is contextually-relevant to the user with regard to the tracked activity based on the first sensor data (received from sensor(s) 414H), the second sensor data (received from sensor(s) 414A-414G and 4141), and the third sensor data (received from sensor(s) 412).

In step 312, the contextually-relevant information is provided to a device that is utilized by the user. For example, with reference to FIG. 4, recommendation engine 424 may provide the contextually-relevant information to a device associated with a user (e.g., a mobile device) via network 408.

In accordance with one or more embodiments, when identifying a user at step 304, a user profile associated with the user is retrieved based on the received first sensor data. The information that is contextually relevant to the user with regard to the tracked activity is based on the user profile, the second sensor data, and the third sensor data. For example, with reference to FIG. 4, when a user is identified using the first sensor data, activity determiner 422 may retrieve a user profile (e.g., user profile(s) 416) associated with the user. The user profile may comprise demographic information, biographical and/or physiological information, and/or behavioral and/or historical information associated with the user. Recommendation engine 424 may determine contextually-relevant information based on the user profile(s) 416, the second sensor data, and the third sensor data.

In accordance with one or more embodiments, the user profile is updated based on at least one of the first sensor data, the second sensor data, or the third sensor data. For instance, with reference to FIG. 4, user profile updater 426 may update user profile(s) 416 based on at least one of the first sensor data, the second sensor data, or the third sensor data.

In accordance with one or more embodiments, information that is contextually relevant to the user with regard to the tracked activity is determined based on the first sensor data, the second sensor data, the third sensor data, and user profiles associated with other users. For example, with reference to FIG. 4, recommendation engine 424 may determine information that is contextually relevant to the user with regard to the tracked activity based on the first sensor data, the second sensor data, the third sensor data, and user profile(s) 416 associated with other users.

In accordance with one or more embodiments, the information that is contextually relevant is a recommendation for the user to perform a particular action with respect to the tracked activity.

In accordance with one or more embodiments, a determination is made as to whether the particular action was performed. The user profile is updated based on whether the particular action was performed. For example, with reference to FIG. 4, recommendation engine 424 may determine whether the particular action was performed. User profile updater 426 may update user profile(s) 416 associated with the user based on whether the particular action was performed. For instance, the determination may be based on sensor data received from sensor(s) 414A-414G and 414I that monitor the user as he traverses through environment 406 for which the recommendation was made. The determination may also be made based on user input provided by the user to which the recommendation was made. For instance, recommendation engine 424 may prompt the user to either accept or reject the recommended activity. In response to determining that the user has performed the recommended activity, recommendation engine 424 may update user profile(s) 416 associated with the user to indicate the user performed the recommended activity. In response to determining that the user has not performed the recommended activity, recommendation engine 424 may update user profile(s) 416 associated with the user to indicate that the user has not performed the recommended activity. Recommendation engine 424 may factor in the positive and/or negative determinations when recommending activity to the user. By doing so, recommendation engine 424 may fine tune the recommendations.

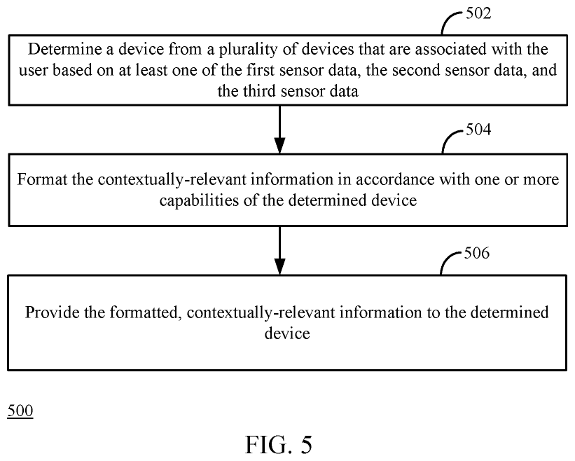

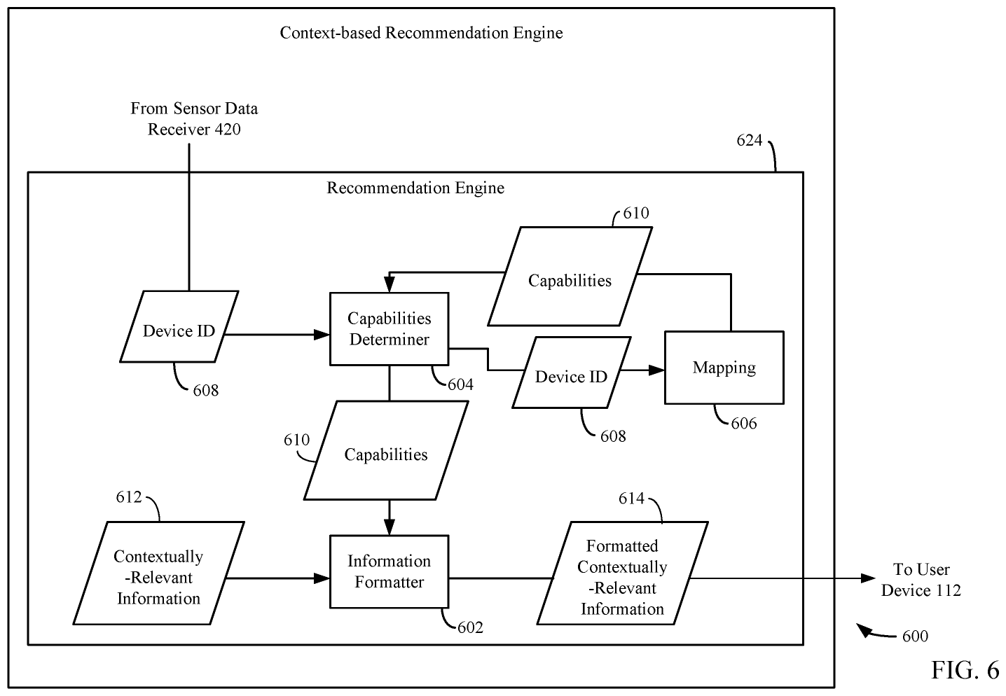

In accordance with one or more embodiments, context-based recommendation engine 410 is configured to format and provide the contextually-relevant information based on capabilities of the device to which the information is provided. For instance, FIG. 5 shows a flowchart 500 of a method for formatting and providing the contextually-relevant information to a device in accordance with an example embodiment. In an embodiment, flowchart 500 may be implemented by a context-based recommendation engine 600 shown in FIG. 6, although the method is not limited to that implementation. FIG. 6 shows a block diagram context-based recommendation engine 600, which is configured to format and provide contextually-relevant information to a device in accordance with an example embodiment. Context-based recommendation engine 600 is an example of context-based recommendation engine 410, as described above with reference to FIG. 4. As shown in FIG. 6, context-based recommendation engine 600 includes at least a recommendation engine 624, which is an example of recommendation engine 424, as respectively described with reference to FIG. 4. Recommendation engine 624 may comprise an information formatter 602, a capabilities determiner 604, and a mapping 606. Other structural and operational embodiments will be apparent to persons skilled in the relevant art(s) based on the discussion regarding flowchart 500 and context-based recommendation engine 600 of FIG. 6.

Flowchart 500 begins with step 502. In step 502, a device from a plurality of devices that are associated with the user is determined based on at least one of the first sensor data, the second sensor data, and the third sensor data. For example, with reference to FIG. 6, recommendation engine 624 may determine a device (e.g., user device 112, as shown in FIG. 1) from a plurality of devices based on user preferences (e.g., specified in the user's profile) and/or via a prioritization scheme. The devices(s) being used by the user may be detected based on wireless network-based or Bluetooth™-based sensors that detect the present of wireless network and/or Bluetooth™-enabled devices, such as a mobile phone, a tablet, a laptop, a smart watch, an augmented reality headset, etc.

In step 504, the contextually-relevant information is formatted in accordance with one or more capabilities of the determined device. For instance, with reference to FIG. 6, capabilities determiner 604 may receive a device identifier 608 from sensor data receiver 420. Device identifier 608 may be transmitted from the device and detected by a sensor (e.g., a wireless network-based and/or Bluetooth™-based sensor). The sensor may provide device identifier 608 to sensor data receiver 420 as part of the sensor data. Capabilities determiner 604 provides device identifier 608 to mapping 606. Mapping 606 may be a a device-to-capability mapping, which maps different devices to their respective capabilities based on their device identifier. Recommendation engine 624 may perform a look up of that device's capabilities using device identifier 608 and mapping 606. Mapping 606 may return capabilities 610 that are associated with device identifier 608 provided thereto. Capabilities determiner 604 provides capabilities 610 to information formatter 602. Information formatter 602 may be configured to format the contextually-relevant information (e.g., contextually-relevant information 612, as determined by recommendation engine 624) in accordance with capabilities 610.

In step 506, the formatted, contextually-relevant information is provided to the determined device. For example, with reference to FIG. 6, information formatter 602 provides the formatted contextually-relevant information (e.g., formatted contextually-relevant information 614) to the device (e.g., user device 112).

### III. Example Mobile Device Implementation

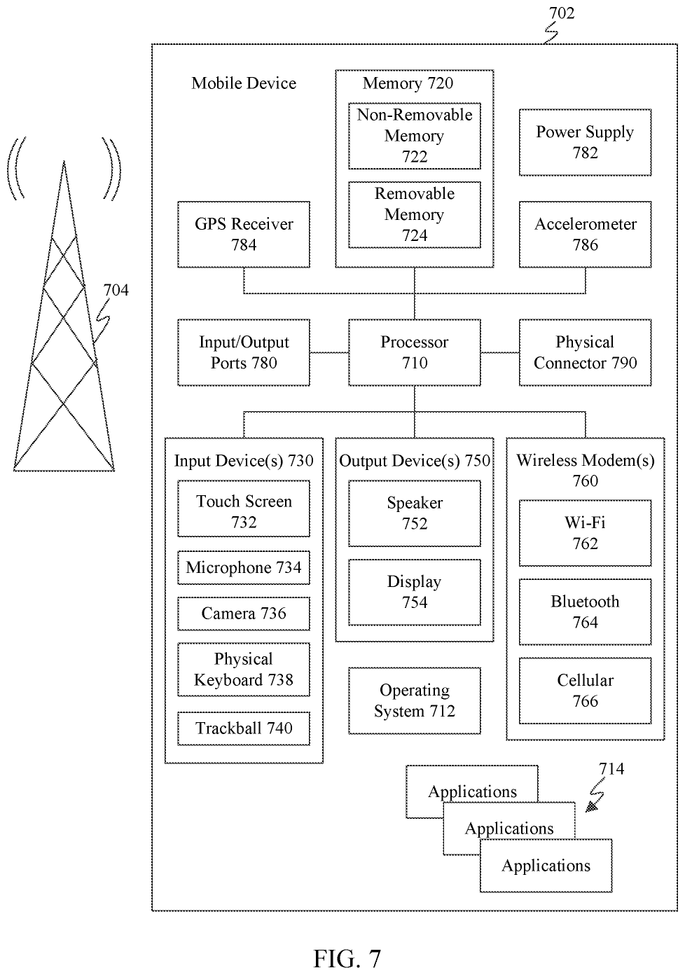

FIG. 7 is a block diagram of an exemplary mobile device 702 that may implement embodiments described herein. For example, mobile device 702 may be used to implement user device 112 of FIG. 1. As shown in FIG. 7, mobile device 702 includes a variety of optional hardware and software components. Any component in mobile device 702 can communicate with any other component, although not all connections are shown for ease of illustration. Mobile device 702 can be any of a variety of computing devices (e.g., cell phone, smart phone, handheld computer, Personal Digital Assistant (PDA), etc.) and can allow wireless two-way communications with one or more mobile communications networks 704, such as a cellular or satellite network, or with a local area or wide area network. Mobile device 702 can also be any of a variety of wearable computing device (e.g., a smart watch, an augmented reality headset, etc.).

Mobile device 702 can include a controller or processor 710 (e.g., signal processor, microprocessor, ASIC, or other control and processing logic circuitry) for performing such tasks as signal coding, data processing, input/output processing, power control, and/or other functions. An operating system 712 can control the allocation and usage of the components of mobile device 702 and provide support for one or more application programs 714 (also referred to as “applications” or “apps”). Application programs 714 may include common mobile computing applications (e.g., e-mail applications, calendars, contact managers, web browsers, messaging applications) and any other computing applications (e.g., word processing applications, mapping applications, media player applications).

Mobile device 702 can include memory 720. Memory 720 can include non-removable memory 722 and/or removable memory 724. Non-removable memory 722 can include RAM, ROM, flash memory, a hard disk, or other well-known memory devices or technologies. Removable memory 724 can include flash memory or a Subscriber Identity Module (SIM) card, which is well known in GSM communication systems, or other well-known memory devices or technologies, such as “smart cards.” Memory 720 can be used for storing data and/or code for running operating system 712 and application programs 714. Example data can include web pages, text, images, sound files, video data, or other data to be sent to and/or received from one or more network servers or other devices via one or more wired or wireless networks. Memory 720 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

Mobile device 702 can support one or more input devices 730, such as a touch screen 732, a microphone 734, a camera 736, a physical keyboard 738 and/or a trackball 740 and one or more output devices 750, such as a speaker 752 and a display 754. Other possible output devices (not shown) can include piezoelectric or other haptic output devices. Some devices can serve more than one input/output function. For example, touch screen 732 and display 754 can be combined in a single input/output device. Input devices 730 can include a Natural User Interface (NUI).

Wireless modem(s) 760 can be coupled to antenna(s) (not shown) and can support two-way communications between processor 710 and external devices, as is well understood in the art. Modem(s) 760 are shown generically and can include a cellular modem 766 for communicating with the mobile communication network 704 and/or other radio-based modems (e.g., Bluetooth 764 and/or Wi-Fi 762). At least one of wireless modem(s) 760 is typically configured for communication with one or more cellular networks, such as a GSM network for data and voice communications within a single cellular network, between cellular networks, or between the mobile device and a public switched telephone network (PSTN).

Mobile device 702 can further include at least one input/output port 780, a power supply 782, a satellite navigation system receiver 784, such as a Global Positioning System (GPS) receiver, an accelerometer 786, and/or a physical connector 790, which can be a USB port, IEEE 1394 (FireWire) port, and/or RS-232 port. The illustrated components of mobile device 702 are not required or all-inclusive, as any components can be deleted and other components can be added as would be recognized by one skilled in the art.

In an embodiment, mobile device 702 is configured to implement any of the above-described features of context-based recommendation engine 110 of FIG. 1, context-based recommendation engine 210 of FIG. 2, context-based recommendation engine 410 of FIG. 4, or context-based recommendation engine 600 of FIG. 6. Computer program logic for performing the functions of these devices may be stored in memory 720 and executed by processor 710.

### IV. Example Computer System Implementation

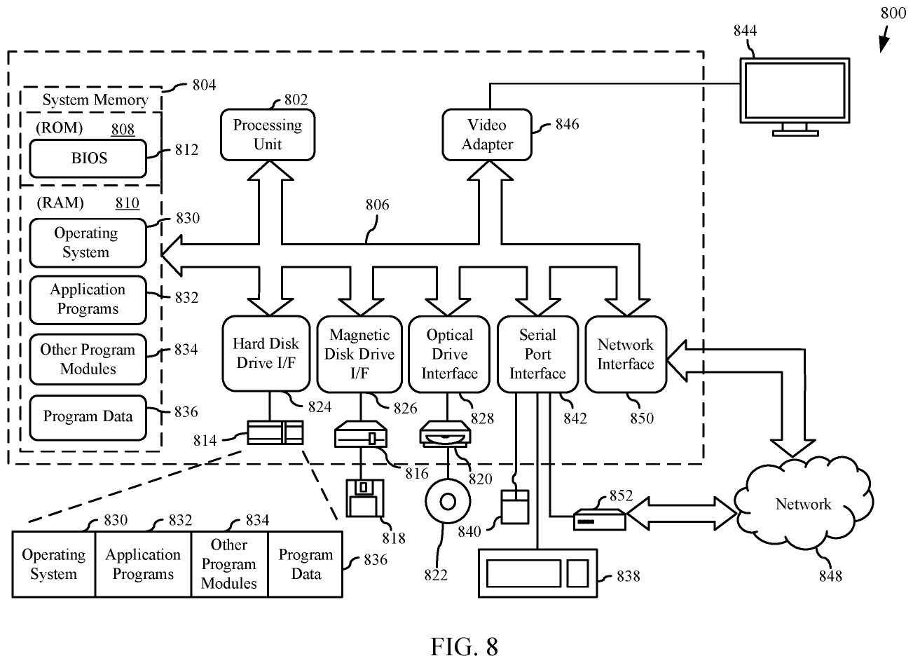

FIG. 8 depicts an example processor-based computer system 800 that may be used to implement various embodiments described herein. For example, system 800 may be used to implement user device 112, server 102, or context-based recommendation engine 110, as described above with reference to FIG. 1, server 202 and context-based recommendation engine 210, as described above with reference to FIG. 2, context-based recommendation engine 410, as described above with reference to FIG. 4, or context-based recommendation engine 600, as described above with reference to FIG. 6. System 800 may also be used to implement any of the steps of any of the flowcharts of FIGS. 3 and 5, as described above. The description of system 800 provided herein is provided for purposes of illustration, and is not intended to be limiting. Embodiments may be implemented in further types of computer systems, as would be known to persons skilled in the relevant art(s).

As shown in FIG. 8, system 800 includes a processing unit 802, a system memory 804, and a bus 806 that couples various system components including system memory 804 to processing unit 802. Processing unit 802 may comprise one or more circuits, microprocessors or microprocessor cores. Bus 806 represents one or more of any of several types of bus structures, including a memory bus or memory controller, a peripheral bus, an accelerated graphics port, and a processor or local bus using any of a variety of bus architectures. System memory 804 includes read only memory (ROM) 808 and random access memory (RAM) 810. A basic input/output system 812 (BIOS) is stored in ROM 808.

System 800 also has one or more of the following drives: a hard disk drive 814 for reading from and writing to a hard disk, a magnetic disk drive 816 for reading from or writing to a removable magnetic disk 818, and an optical disk drive 820 for reading from or writing to a removable optical disk 822 such as a CD ROM, DVD ROM, BLU-RAY™ disk or other optical media. Hard disk drive 814, magnetic disk drive 816, and optical disk drive 820 are connected to bus 806 by a hard disk drive interface 824, a magnetic disk drive interface 826, and an optical drive interface 828, respectively. The drives and their associated computer-readable media provide nonvolatile storage of computer-readable instructions, data structures, program modules and other data for the computer. Although a hard disk, a removable magnetic disk and a removable optical disk are described, other types of computer-readable memory devices and storage structures can be used to store data, such as flash memory cards, digital video disks, random access memories (RAMs), read only memories (ROM), and the like.

A number of program modules may be stored on the hard disk, magnetic disk, optical disk, ROM, or RAM. These program modules include an operating system 830, one or more application programs 832, other program modules 834, and program data 836. In accordance with various embodiments, the program modules may include computer program logic that is executable by processing unit 802 to perform any or all of the functions and features of user device 112, server 102, or context-based recommendation engine 110, as described above with reference to FIG. 1, server 202 and context-based recommendation engine 210, as described above with reference to FIG. 2, context-based recommendation engine 410, as described above with reference to FIG. 4, or context-based recommendation engine 600, as described above with reference to FIG. 6. The program modules may also include computer program logic that, when executed by processing unit 802, causes processing unit 802 to perform any of the steps of any of the flowcharts of FIGS. 3 and 5, as described above.

A user may enter commands and information into system 800 through input devices such as a keyboard 838 and a pointing device 840 (e.g., a mouse). Other input devices (not shown) may include a microphone, joystick, game controller, scanner, or the like. In one embodiment, a touch screen is provided in conjunction with a display 844 to allow a user to provide user input via the application of a touch (as by a finger or stylus for example) to one or more points on the touch screen. These and other input devices are often connected to processing unit 802 through a serial port interface 842 that is coupled to bus 806, but may be connected by other interfaces, such as a parallel port, game port, or a universal serial bus (USB). Such interfaces may be wired or wireless interfaces.

Display 844 is connected to bus 806 via an interface, such as a video adapter 846. In addition to display 844, system 800 may include other peripheral output devices (not shown) such as speakers and printers.

System 800 is connected to a network 848 (e.g., a local area network or wide area network such as the Internet) through a network interface 850, a modem 852, or other suitable means for establishing communications over the network. Modem 852, which may be internal or external, is connected to bus 806 via serial port interface 842.

As used herein, the terms “computer program medium,” “computer-readable medium,” and “computer-readable storage medium” are used to generally refer to memory devices or storage structures such as the hard disk associated with hard disk drive 814, removable magnetic disk 818, removable optical disk 822, as well as other memory devices or storage structures such as flash memory cards, digital video disks, random access memories (RAMs), read only memories (ROM), and the like. Such computer-readable storage media are distinguished from and non-overlapping with communication media (do not include communication media or modulated data signals). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media.

As noted above, computer programs and modules (including application programs 832 and other program modules 834) may be stored on the hard disk, magnetic disk, optical disk, ROM, or RAM. Such computer programs may also be received via network interface 850, serial port interface 842, or any other interface type. Such computer programs, when executed or loaded by an application, enable system 1700 to implement features of embodiments discussed herein. Accordingly, such computer programs represent controllers of the system 800. Embodiments are also directed to computer program products comprising software stored on any computer useable medium. Such software, when executed in one or more data processing devices, causes a data processing device(s) to operate as described herein. Embodiments may employ any computer-useable or computer-readable medium, known now or in the future. Examples of computer-readable mediums include, but are not limited to memory devices and storage structures such as RAM, hard drives, floppy disks, CD ROMs, DVD ROMs, zip disks, tapes, magnetic storage devices, optical storage devices, MEMs, nanotechnology-based storage devices, and the like.

In alternative implementations, system 800 may be implemented as hardware logic/electrical circuitry or firmware. In accordance with further embodiments, one or more of these components may be implemented in a system-on-chip (SoC). The SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

### V. Additional Example Embodiments

A method is described herein. The method includes: receiving first sensor data from first sensors located in a first environment; identifying a user based on the received first sensor data; determining an activity of the user within the first environment by second sensor data received from second sensors located in the first environment; receiving third sensor data regarding the user from third sensors located in a second environment; determining information that is contextually relevant to the user with regard to the tracked activity based on the first sensor data, the second sensor data, and the third sensor data; and providing the contextually-relevant information to a device utilized by the user.

In one implementation of the foregoing method, said identifying comprises: retrieving a user profile associated the user based on the received first sensor data; and wherein said determining information comprises: determining information that is contextually relevant to the user with regard to the tracked activity based on the user profile, the second sensor data, and the third sensor data.

In another implementation of the foregoing method, the method further comprises: updating the user profile based on at least one of the first sensor data, the second sensor data, or the third sensor data.

In another implementation of the foregoing method, said determining information comprises: determining information that is contextually relevant to the user with regard to the tracked activity based on the first sensor data, the second sensor data, the third sensor data, and user profiles associated with other users.

In another implementation of the foregoing method, the information that is contextually relevant is a recommendation for the user to perform a particular action with respect to the tracked activity.

In another implementation of the foregoing method, the method further comprises: determining whether the particular action was performed; and updating the user profile based on whether the particular action was performed.

In another implementation of the foregoing method, said providing comprises: determining a device from a plurality of devices that are associated with the user based on at least one of the first sensor data, the second sensor data, and the third sensor data; formatting the contextually-relevant information in accordance with one or more capabilities of the determined device; and providing the formatted, contextually-relevant information to the determined device.

In another implementation of the foregoing method, at least one of the first sensors, the second sensors, or the third sensors are included in at least one of a smart phone or a wearable computing device.

In another implementation of the foregoing method, said determining the activity of the user within the first environment comprising: continuously tracking a movement of the user within the first environment via the second sensors; and determining a destination within the first environment to which the user is headed based on said continuously tracking, and wherein the contextually-relevant information is related to the determined destination.

In another implementation of the method, providing the contextually-relevant information to the device comprises: providing the contextually-relevant information to the device before the user arrives at the destination.

A computing device is also described herein. The computing device includes: at least one processor circuit; and at least one memory that stores program code configured to be executed by the at least one processor circuit, the program code comprising: a sensor data receiver configured to: receiving first sensor data from first sensors located in a first environment; an activity determiner configured to: identify a user based on the received first sensor data; and determine an activity of the user within the first environment by second sensor data received from second sensors located in the first environment, the sensor data receiver further configured to receive third sensor data regarding the user from third sensors located in a second environment; and a recommendation engine configured to: determine information that is contextually relevant to the user with regard to the tracked activity based on the first sensor data, the second sensor data, and the third sensor data; and provide the contextually-relevant information to a device utilized by the user.

In one implementation of the foregoing computing device, the activity determiner is further configured to: retrieve a user profile associated the user based on the received first sensor data; and wherein the recommendation engine is further configured to: determine information that is contextually relevant to the user with regard to the tracked activity based on the user profile, the second sensor data, and the third sensor data.

In another implementation of the foregoing computing device, the program code further comprises: a user profile updater configured to update the user profile based on at least one of the first sensor data, the second sensor data, or the third sensor data.

In another implementation of the foregoing computing device, the recommendation engine is further configured to: determine information that is contextually relevant to the user with regard to the tracked activity based on the first sensor data, the second sensor data, the third sensor data, and user profiles associated with other users.

In another implementation of the foregoing computing device, the information that is contextually relevant is a recommendation for the user to perform a particular action with respect to the tracked activity.

In another implementation of the foregoing computing device, the recommendation engine is further configured to: determine whether the particular action was performed; and wherein the user profile updater is further configured to: update the user profile based on whether the particular action was performed. method further includes providing, for presentation in the user interface, a measure of similarity between the incident notification and the similar unresolved incident notification.

In another implementation of the foregoing computing device, the recommendation engine is further configured to: determine a device from a plurality of devices that are associated with the user based on at least one of the first sensor data, the second sensor data, and the third sensor data; format the contextually-relevant information in accordance with one or more capabilities of the determined device; and provide the formatted, contextually-relevant information to the determined device.

A computer-readable storage medium having program instructions recorded thereon that, when executed by at least one processor, perform a method. The method includes: receiving first sensor data from first sensors located in a first environment; identifying a user based on the received first sensor data; determining an activity of the user within the first environment by second sensor data received from second sensors located in the first environment; receiving third sensor data regarding the user from third sensors located in a second environment; determining information that is contextually relevant to the user with regard to the tracked activity based on the first sensor data, the second sensor data, and the third sensor data; and providing the contextually-relevant information to a device utilized by the user.

In another implementation of the foregoing computer-readable storage medium, said identifying comprises: retrieving a user profile associated the user based on the received first sensor data; and wherein said determining information comprises: determining information that is contextually relevant to the user with regard to the tracked activity based on the user profile, the second sensor data, and the third sensor data.

In another implementation of the foregoing computer-readable storage medium, the method further includes: updating the user profile based on at least one of the first sensor data, the second sensor data, or the third sensor data.

### VI. Conclusion

While various example embodiments have been described above, it should be understood that they have been presented by way of example only, and not limitation. It will be understood by those skilled in the relevant art(s) that various changes in form and details may be made therein without departing from the spirit and scope of the embodiments as defined in the appended claims. Accordingly, the breadth and scope of the present invention should not be limited by any of the above-described example embodiments, but should be defined only in accordance with the following claims and their equivalents.

What is claimed is:

1. A method, comprising:
receiving first sensor data from first sensors located in a first environment;
identifying a user based on the received first sensor data;
determining an activity of the user within the first environment by second sensor data received from second sensors located in the first environment;
receiving third sensor data regarding the user from third sensors located in a second environment;
determining information that is contextually relevant to the user with regard to the tracked activity based on the first sensor data, the second sensor data, and the third sensor data; and
providing the contextually-relevant information to a device utilized by the user.

2. The method of claim 1, wherein said identifying comprises:
retrieving a user profile associated the user based on the received first sensor data; and
wherein said determining information comprises:
determining information that is contextually relevant to the user with regard to the tracked activity based on the user profile, the second sensor data, and the third sensor data.

3. The method of claim 2, further comprising:
updating the user profile based on at least one of the first sensor data, the second sensor data, or the third sensor data.

4. The method of claim 2, wherein said determining information comprises:
determining information that is contextually relevant to the user with regard to the tracked activity based on the first sensor data, the second sensor data, the third sensor data, and user profiles associated with other users.

5. The method of claim 2, wherein the information that is contextually relevant is a recommendation for the user to perform a particular action with respect to the tracked activity.

6. The method of claim 5, further comprising:
determining whether the particular action was performed; and
updating the user profile based on whether the particular action was performed.

7. The method of claim 1, wherein said providing comprises:
determining a device from a plurality of devices that are associated with the user based on at least one of the first sensor data, the second sensor data, and the third sensor data;
formatting the contextually-relevant information in accordance with one or more capabilities of the determined device; and
providing the formatted, contextually-relevant information to the determined device.

8. The method of claim 1, wherein at least one of the first sensors, the second sensors, or the third sensors are included in at least one of a smart phone or a wearable computing device.

9. The method of claim 1, wherein said determining the activity of the user within the first environment comprising:
continuously tracking a movement of the user within the first environment via the second sensors; and
determining a destination within the first environment to which the user is headed based on said continuously tracking, and
wherein the contextually-relevant information is related to the determined destination.

10. The method of claim 10, wherein providing the contextually-relevant information to the device comprises:
providing the contextually-relevant information to the device before the user arrives at the destination.

11. A computing device, comprising:
at least one processor circuit; and
at least one memory that stores program code configured to be executed by the at least one processor circuit, the program code comprising:
a sensor data receiver configured to:
receiving first sensor data from first sensors located in a first environment;
an activity determiner configured to:
identify a user based on the received first sensor data; and
determine an activity of the user within the first environment by second sensor data received from second sensors located in the first environment, the sensor data receiver further configured to receive third sensor data regarding the user from third sensors located in a second environment; and
a recommendation engine configured to:
determine information that is contextually relevant to the user with regard to the tracked activity based on the first sensor data, the second sensor data, and the third sensor data; and
provide the contextually-relevant information to a device utilized by the user.

12. The computing device of claim 11, wherein the activity determiner is further configured to:
retrieve a user profile associated the user based on the received first sensor data; and wherein the recommendation engine is further configured to:
determine information that is contextually relevant to the user with regard to the tracked activity based on the user profile, the second sensor data, and the third sensor data.

13. The computing device of claim 12, the program code further comprising:
a user profile updater configured to update the user profile based on at least one of the first sensor data, the second sensor data, or the third sensor data.

14. The computing device of claim 12, wherein the recommendation engine is further configured to:
determine information that is contextually relevant to the user with regard to the tracked activity based on the first sensor data, the second sensor data, the third sensor data, and user profiles associated with other users.

15. The computing device of claim 11, wherein the information that is contextually relevant is a recommendation for the user to perform a particular action with respect to the tracked activity.

16. The computing device of claim 13, wherein the recommendation engine is further configured to:
determine whether the particular action was performed; and
wherein the user profile updater is further configured to:
update the user profile based on whether the particular action was performed.

17. The computing device of claim 11, wherein the recommendation engine is further configured to:
determine a device from a plurality of devices that are associated with the user based on at least one of the first sensor data, the second sensor data, and the third sensor data;
format the contextually-relevant information in accordance with one or more capabilities of the determined device; and
provide the formatted, contextually-relevant information to the determined device.

18. A computer-readable storage medium having program instructions recorded thereon that, when executed by at least one processor, perform a method, the method comprising:
receiving first sensor data from first sensors located in a first environment;
identifying a user based on the received first sensor data;
determining an activity of the user within the first environment by second sensor data received from second sensors located in the first environment;
receiving third sensor data regarding the user from third sensors located in a second environment;
determining information that is contextually relevant to the user with regard to the tracked activity based on the first sensor data, the second sensor data, and the third sensor data; and
providing the contextually-relevant information to a device utilized by the user.

19. The computer-readable storage medium of claim 18, wherein said identifying comprises:
retrieving a user profile associated the user based on the received first sensor data; and
wherein said determining information comprises:
determining information that is contextually relevant to the user with regard to the tracked activity based on the user profile, the second sensor data, and the third sensor data.

20. The computer-readable storage medium of claim 19, the method further comprising:
updating the user profile based on at least one of the first sensor data, the second sensor data, or the third sensor data.
